(19) United States
(12) Patent Application Publication
(10) Pub. No.: US 2014/0279008 A1
(43) Pub. Date: Sep. 18, 2014

(54) PROVIDING AN OFFER BASED ON ENROLLING A DEBIT ACCOUNT INTO A MERCHANT-SPECIFIC ACCOUNT

(71) Applicant: BANK OF AMERICA CORPORATION, Charlotte, NC (US)

(72) Inventors: Matthew A. Calman, Charlotte, NC (US); David M. Grigg, Rock Hill, SC (US)

(73) Assignee: BANK OF AMERICA CORPORATION, Charlotte, NC (US)

(21) Appl. No.: 13/828,849

(22) Filed: Mar. 14, 2013

(51) Int. Cl. G06Q 30/02

(52) U.S. Cl. CPC G06Q 30/0215
USPC 705/14.58; 705/14.49

(57) ABSTRACT

Embodiments of the present invention relate to systems, methods, and computer program products for providing an offer to a user based on linking a financial account to a merchant-specific account. In some embodiments, a method is provided that includes: (a) determining whether a user is a holder of an existing merchant-specific account; (b) prompting the user to link a debit account to the existing merchant-specific account based at least partially on determining that the user is the holder of the existing merchant-specific account; (c) receiving debit account information for linking the existing merchant-specific account to the debit account of the user; and (d) providing the offer to the user based on successfully linking the debit account to the merchant-specific account.

### BACKGROUND

Many merchants, e.g. retailers, financial institutions etc., provide their customers with a customer loyalty rewards program. Typically, customers that participate in these programs receive some defined benefit in exchange for continuing to be an active customer of the merchant. Some of these loyalty programs may be associated with merchant issued credit or prepaid accounts. In order to enhance the operability of the merchant issued credit or prepaid accounts, it is beneficial to a merchant that the customer link a debit account for ease of funding of the accounts and payment of purchases. As such, there is a need to incentive customers to enroll merchant issued accounts in such programs.

### BRIEF SUMMARY

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

Some embodiments of the present invention provide a system that includes a memory device and a processing device, computer executable instructions stored on the memory device when executed by the processing device causes the computer to: (a) determine whether a user is a holder of an existing merchant-specific account; (b) prompt the user to link a debit account to the existing merchant-specific account based at least partially on determining that the user is the holder of the existing merchant-specific account; (c) receive debit account information for linking the existing merchant-specific account to the debit account of the user; and (d) provide, via the communication device, the offer to the user based on successfully linking the debit account to the merchant-specific account.

In some embodiments of the system, the merchant-specific account of the user is a prepaid account or a credit account.

In some embodiments of the system, prompting the user to link a debit account is further based on determining a location of the user and determining that the location of the user is proximate to or coincident with a location of the merchant.

In some embodiments of the system, the prompt is selectable by the user and wherein the prompt is configured to present a display for receiving input from the user relating to the debit account being linked to the merchant-specific account.

In some embodiments of the system, the offer presented to the consumer is for a discount off of a current, prior, or future purchase.

In some embodiments of the system, the memory comprising executable instructions that when executed by the processor further causes the processor to: (a) send a notification to a merchant associated with the merchant-specific account, the notification comprising information indicating that the consumer is at or near a location of the merchant and further indicating that the consumer is the holder of the merchant-specific account; and (b) allow the merchant to send, in real-time or substantially real-time, the offer to the mobile device associated with the consumer and while the consumer is at or near the merchant.

In some embodiments of the system, the system for providing the offer is a self-service device useable by the user for receiving the prompt, providing debit account information for linking, and receiving the offer.

In one aspect of the invention, a computer-implemented method is provided for presenting an offer based on a location of a consumer having a credit account associated with a merchant. The computer-implemented method includes using a computer processor to execute computer program code instructions stored in one or more non-transitory computer-readable mediums, wherein said computer program code instructions are structured to cause said computer processor to: (a) determine whether a user is a holder of an existing merchant-specific account; (b) prompt the user to link a debit account to the existing merchant-specific account based at least partially on determining that the user is the holder of the existing merchant-specific account; (c) receive debit account information for linking the existing merchant-specific account to the debit account of the user; and (d) provide, via the communication device, the offer to the user based on successfully linking the debit account to the merchant-specific account.

In some embodiments of the computer-implemented method, the merchant-specific account of the user is a prepaid account or a credit account.

In some embodiments of the computer-implemented method, prompting the user to link a debit account is further based on determining a location of the user and determining that the location of the user is proximate to or coincident with a location of the merchant.

In some embodiments of the computer-implemented method, the prompt is selectable by the user and wherein the prompt is configured to present a display for receiving input from the user relating to the debit account being linked to the merchant-specific account.

In some embodiments of the computer-implemented method, the offer presented to the consumer is for a discount off of a current, prior, or future purchase.

In some embodiments of the computer-implemented method, the processing device is further configured to: (a) send a notification to a merchant associated with the merchant-specific account, the notification comprising information indicating that the consumer is at or near a location of the merchant and further indicating that the consumer is the holder of the merchant-specific account; and (b) allow the merchant to send, in real-time or substantially real-time, the offer to the mobile device associated with the consumer and while the consumer is at or near the merchant.

In some embodiments of the computer-implemented method, the system for providing the offer is a self-service device useable by the user for receiving the prompt, providing debit account information for linking, and receiving the offer.

In another aspect, a computer program product for providing information related to a goal of a user is provided that includes a non-transitory computer-readable medium, wherein the non-transitory computer-readable medium comprises one or more computer-executable program code portions that, when executed by a computer, cause the computer to: (a) determine whether a user is a holder of an existing merchant-specific account; (b) prompt the user to link a debit account to the existing merchant-specific account based at least partially on determining that the user is the holder of the existing merchant-specific account; (c) receive debit account information for linking the existing merchant-specific account to the debit account of the user; and (d) provide, via the communication device, the offer to the user based on successfully linking the debit account to the merchant-specific account.

In some embodiments of the computer program product, the merchant-specific account of the user is a prepaid account or a credit account.

In some embodiments of the computer program product, prompting the user to link a debit account is further based on determining a location of the user and determining that the location of the user is proximate to or coincident with a location of the merchant.

In some embodiments of the computer program product, the prompt is selectable by the user and wherein the prompt is configured to present a display for receiving input from the user relating to the debit account being linked to the merchant-specific account.

In some embodiments of the computer program product, the offer presented to the consumer is for a discount off of a current, prior, or future purchase.

In some embodiments of the computer program product, the processing device is further configured to: (a) send a notification to a merchant associated with the merchant-specific account, the notification comprising information indicating that the consumer is at or near a location of the merchant and further indicating that the consumer is the holder of the merchant-specific account; and (b) allow the merchant to send, in real-time or substantially real-time, the offer to the mobile device associated with the consumer and while the consumer is at or near the merchant.

In some embodiments of the computer program product, the system for providing the offer is a self-service device useable by the user for receiving the prompt, providing debit account information for linking, and receiving the offer.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram illustrating an environment for presenting an offer based on linking a debit account to a merchant-specific account, in accordance with an embodiment of the invention;

FIG. 2 provides a block diagram illustrating the mobile computing device of a consumer of FIG. 1 in more detail, in accordance with an embodiment of the invention;

FIG. 3 provides a block diagram illustrating the financial management system of FIG. 1 in more detail, in accordance with an embodiment of the invention;

FIG. 4 provides a block diagram illustrating the merchant system of FIG. 1 in more detail, in accordance with an embodiment of the invention;

FIG. 5 provides a block diagram illustrating the account communication system of FIG. 1 in more detail, in accordance with an embodiment of the invention;

FIG. 6 provides a flow chart illustrating presenting an offer based on linking a debit account to a merchant-specific account, in accordance with some embodiments of the present invention;

### DETAILED DESCRIPTION OF EMBODIMENTS OF THE INVENTION

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Additionally, while embodiments are disclosed as “comprising” elements, it should be understood that the embodiments may also “consist of” elements or “consist essentially of” elements.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. As used herein, the term “user” includes a customer of a financial institution, a financial account holder, an agent of an account holder, a user associated with a payment device, a merchant, an employee of a merchant, a business or non-profit entity, and the like. The term “merchant” may mean a brick and mortar merchant, an internet retailer a service provider, a mobile merchant, or the like, and thus a point of sale for a transaction may instead by a time of sale for the transaction.

As used herein, the terms “prepaid account” refers to a deposit account that is associated with a prepaid card, mobile payment device, in-store managed account, or electronic payment device that can be loaded and/or reloaded with funds. In some embodiments, the holder of the prepaid account can exceed the available funds or credit in the account and in other embodiments, the holder of the prepaid account cannot exceed the available funds in the prepaid account. In some embodiments, the prepaid card account may be used to engage in one or more transactions but only if those one or more transactions are “paid for” in advance. Additionally or alternatively, in some embodiments, the prepaid card account is not a conventional checking account, savings account, credit card account, or the like. Further, in some embodiments, the prepaid card account is not linked or otherwise tied to a deposit account, credit account, master account, or sub-account. This is not to say, however, that the prepaid card account cannot be loaded and/or reloaded with funds from one or more deposit and/or credit accounts. For example, in some embodiments, the holder of the prepaid card account may use the holder's checking account to load the prepaid card account with funds; however, if the prepaid card account attempts to engage in a transaction exceeding the available funds in the prepaid card account, the checking account cannot be used to cover the amount exceeding the available balance of the prepaid account. In some embodiments, the prepaid account is issued by a merchant and/or an affiliate of the merchant in which case, the prepaid account is determined to be a merchant-specific merchant account that, in most instances, can only be used to purchase goods and/or services from the merchant. The prepaid account may be used to purchase goods and/or services at merchant locations or at an online site with merchant goods and/or services or at an online webpage associated with a merchant.

As used herein, the terms “credit account” refer to a non-deposit account that is associated with a credit card, mobile payment device, online account, or electronic payment device that extends credit to the consumer. The credit extended to the consumer may be used to engage in one or more transactions without expending the money of the consumer or to make various purchases of goods and/or services. In some embodiments, the credit account has a credit limit which the user cannot exceed, but in some instances, the issuer of the credit account allows the user to exceed the available credit or credit limit of the credit account when making a purchase. In some embodiments, the credit account is issued by a merchant and/or an affiliate of the merchant, in which case, the credit account is determined to be a merchant-specific account that, in most cases, can only be used to purchase goods and/or services from the merchant. The credit account may be used to purchase goods and/or services at merchant locations or at an online site with goods and/or services of the merchant or at an online webpage associated with a merchant.

Methods, systems, apparatuses, and computer program products are described herein for communicating an offer to a consumer who enrolls into a merchant loyalty program by linking his merchant-specific account to a debit account. In some manner, a merchant associated with a merchant-specific account of a consumer may determine that the merchant-specific account is eligible to be linked with a debit account of the consumer. A merchant can use positioning and/or transaction data for determining the eligibility of the user. Once the merchant determines that the user can link his merchant-specific account, the merchant will contact the user, via a mobile device, in order to provide that user with an offer based on the user linking his debit account to the merchant-specific account. Linking the debit account of the use to the merchant-specific account allows for the transferring of funds and/or credits between the linked accounts.

FIG. 1 provides a block diagram illustrating a system and environment 100 in accordance with an embodiment of the invention. As illustrated, the system 100 generally includes a consumer 110, a network 120, a positioning system 150, a consumer mobile device 200, a financial management system 300, and a merchant system 400, and an account communication system 500.

The consumer 110 has a mobile device 200, such as a mobile phone, personal digital assistant (PDA), personal navigation device, personal web-surfing device, or other personal/mobile computing device. Embodiments of the consumer mobile device 200 are described in greater detail in FIG. 2 and the accompanying description.

The network 120 may be any of one or more devices or connections communicably coupling two or more devices. For example, the network 120 may include a global area network, such as the Internet, a wide area network, a local area network, a wireless network, a wire-line network, one or more modems, one or more servers, one or more relay devices, one or more direct electrical connections, one or more satellites, and/or the like, or a combination thereof. As illustrated, in some embodiments, the network 120 includes a wireless telephone network 122, such as a cellular network or other mobile telephone/data network known in the art. As also illustrated, in some embodiments, the network 120 includes a payment network 124 for processing electronic or other payments and transferring money between banks and other entities. For example, the payment network 124 may include the networks of one or more banks or other well-known payment network and/or the like.

According to various embodiments, the positioning system 150 may be the Global Positioning System (GPS) or other systems for identifying precise geographical locations of individuals or devices or positions of individuals or devices relative to known objects or locations. For example, some embodiments of the invention include a positioning system that can identify the current latitude and longitude, and in some cases altitude, of the consumer's mobile device 200 using a sensor/transceiver in the consumer's mobile device 200 in conjunction with a satellite system and/or the wireless telephone network 122. In other embodiments, more local sensors/transceivers interact with sensors/transceivers of the consumer's mobile device 200 to determine if the consumer 110 is within a certain distance from a merchant and/or moving toward or away from the merchant. For example, in one embodiment of the invention, a merchant has sensors at its entrances that can communicate with consumer mobile devices 200 that have near field communication (NFC) capabilities and, thereby, determine when the consumer 110 possessing the consumer mobile device 200 enters or leaves the merchant's facility.

The financial management system 300 stores financial information for the consumer110 and/or the merchant, including account information for one or more credit account credit accounts of the consumer 110. Embodiments of the financial management system 300 and credit account information are described in greater detail in FIG. 3 and the accompanying description.

According to various embodiments, the merchant system 400 communicates offers to the consumer 110 and allows the merchant to interact with the credit account communication system 500. The merchant system 400 may also store account balance information (e.g., amount of credit used or amount of credit available on the account credit account). Embodiments of the merchant system 400 are described in greater detail in FIG. 4 and the accompanying description.

According to various embodiments, the account communication system 500 provides relevant credit account or prepaid account information, merchant deals or offers, and/or merchant locations that offer products or services associated with the prepaid account of the consumer to the mobile device 200 when the consumer 110 is near or entering the merchant's facility. Embodiments of the various processes, features, and functions managed by the account balance communication system 500 are described below in FIG. 6 and the accompanying descriptions. Embodiments of the account communication system 500 are also described in greater detail in FIG. 5 and the accompanying description.

For example, as described in greater detail below, in one embodiment of the system 100, a consumer's location relative to one or more merchants is tracked using the positioning system 150 and the consumer's mobile device 200. The account communication system 500 and/or the merchant system 400 receives the position of the consumer's mobile device from the positioning system 150, identifies the merchant(s) or the type(s) of merchant(s) located near the consumer's mobile device 200, retrieves credit or prepaid account information related to each merchant or type of merchant for which the consumer has or maintains a credit account or prepaid account and communicates an offer to the consumer's mobile device 200 for display thereon when the system determines that the consumer has a credit account or prepaid account with a merchant that is located at or near the consumer and when credit account or prepaid account has a balance that has not yet been paid by the consumer. In addition, according to one embodiment, the account communication system 500 and/or the financial management system 300 determines trends in the consumer's shopping behavior based on information stored by the financial management system 300, and these trends are used to determine which of two or more merchants the consumer is more likely to be visiting at a particular time of the day, when, for example, there are two or more merchants located near the consumer's mobile device 200.

FIG. 2 provides a block diagram illustrating the consumer mobile device 200 of FIG. 1 in more detail in accordance with an embodiment of the invention. In one embodiment of the invention, the mobile device 200 is a mobile telephone. However, it should be understood that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, watches (e.g., a wrist watch), glasses (e.g., eye glasses), or any combination of the aforementioned.

The mobile device 200 generally includes a processor 210 communicably coupled to such devices as a memory 220, user output devices 236, user input devices 240, a network interface 260, a power source 215, a clock or other timer 250, a camera 280, and a positioning system device 275. The processor 210 and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. Web browser application 222 may be a continuously running application or an application that is activated by the user at any time. In some embodiments, web browser application 222 maybe in communication and/or in some manner linked to each account or credit account of the consumer. In the same embodiment, web browser application may be continuously operating and tracking the present location of the mobile device and/or consumer associated therewith, such that upon determining that the consumer is in proximity to or at a merchant location associated with a linked credit account, web browser application 222 may automatically (without human intervention) send a notification or communication to the merchant system 400, the account balance communication system 500, or financial management system 300 so that one or more of the systems can initiate an offer to the consumer when or if it determined that a linked credit account or prepaid account has an unpaid or existing balance thereon.

The processor 210 is configured to use the network interface 260 to communicate with one or more other devices on the network 120. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 122. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on the payment network 124. For example, the mobile device 200 may be configured so that it can be used as a credit or debit card by, for example, wirelessly communicating account numbers or other authentication information to a POS terminal of the payment network 124 and/or merchant system 400.

As described above, the mobile device 200 has a user interface that is, like other user interfaces described herein, made up of user output devices 236 and/or user input devices 240. The user output devices 236 include a display 330 (e.g., a liquid crystal display or the like) and a speaker 232 or other audio device, which are operatively coupled to the processor 210. The user input devices 240, which allow the mobile device 200 to receive data from a user such as the consumer 110, may include any of a number of devices allowing the mobile device 200 to receive data from the user, such as a keypad, keyboard, touch-screen, touchpad, microphone, mouse, joystick, other pointer device, button, soft key, and/or other input device(s). The user interface may also include a camera 280, such as a digital camera.

The mobile device 200 also includes a positioning system device 275 that is configured to be used by the positioning system 150 to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the consumer mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 500 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement any functions of the mobile device 200 described herein and/or any other system described herein. For example, the memory 220 may include such applications as a conventional web browser application 222 and/or an account balance communication system client application 221. These applications also typically provide a graphical user interface (GUI) on the display 330 that allows the consumer 110 to communicate with the consumer mobile device 200, the account communication system 500, and/or other devices. In one embodiment of the invention, when the consumer 110 decides to enroll in the account balance communication program, the consumer 110 downloads the account balance communication system client application 221 from the account communication system 500. In other embodiments of the invention, the consumer 110 interacts with the account communication system 500 via the web browser application 220 in addition to, or instead of, the account communication system client application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user preferences information 224 or credit account or prepaid account information 226 related to one or more credit or prepaid accounts of the consumer.

The user preferences information 224 may include, for example, information used by the credit account communication system 500 to determine the identity of the user, what type of credit account or prepaid account information the user wants to see, when the user would like to receive each type of information, how the user would like to receive each type information, when the user would like for the user's location to be available to the merchant system and/or account communication system 500, and/or the like. The user preference information 224 may be requested, for example, by the account communication system client application 221 via the user output devices 236, and may be entered by the consumer 110 via the user input devices 240 and then stored by the processor 210 in the memory 220 and, in some cases, communicated to the account balance communication system 500 via the network interface 260. In some embodiments, the user preferences include a digital certificate or other file used by the account communication system 500 to identify and/or authenticate the consumer 110 associated with the mobile device 200 in a secure and/or encrypted way. Some examples of user preferences 224 are described in greater detail below with reference to the flow charts.

FIG. 3 provides a block diagram illustrating the financial management system 300 of FIG. 1 in more detail in accordance with an embodiment of the invention. The financial management system 300 generally includes a processor 310 communicably coupled to a communication interface 330 and a memory system 320. Like the processor 210 described with respect to FIG. 2, the processor 310 comprises the circuitry and logic to perform the various functions of the financial management system 300 described herein. The communication interface 330 includes a network interface 332 and a user interface 334, which may be similar to those described above with respect to FIG. 2. In one embodiment, the financial management system 300 is a computer system of a bank or other financial institution configured to process financial transactions (e.g., credit or debit card transactions and/or the like) for consumers and/or merchants having accounts with the bank or other financial institution.

According to various embodiments, the memory system 320 stores account and/or account data 321 related to one or more credit accounts of or being held credit account by the consumer 110 and consumer transaction data 322 related to one or more financial transactions made by the consumer 110 through the financial institution and/or using the one or more credit accounts. The account data 321 includes a account issuer, identification of a merchant associated with the credit or prepaid account (if any), the available credit or available funds of the credit account or prepaid account, the interest rate associated with the credit account, terms and conditions of the credit account or prepaid account, a credit used or balance of the credit account or prepaid account, the expiration date of the credit account or prepaid account, credit account or prepaid account notification rules associated with each credit account, according to various embodiments.

Furthermore, financial institutions have access to large amounts of consumer data because they maintain or administer their customers' various financial accounts (e.g., credit card accounts, checking accounts, savings accounts, etc.) and because they have data related to their customers' purchases. Financial institutions track and store data related to the goods or services (e.g., “products”) that customers purchase, when their customers make their purchases, where the customers make their purchases, how much the customers spend, and/or the like, both for online and offline purchases. In addition, financial institutions have direct ties with many different merchants that use the financial institutions for their own financial needs. Accordingly, financial institutions are in a unique position to track consumer transaction data for purchases made by the consumer. In various embodiments, the consumer transaction data 322 includes information about one or more consumer transactions, such as transaction amount, date/time, location, merchant, products, transaction type, payment method, and/or the like. In addition, according to some embodiments, the financial system 300 may also track spending trends of the consumer 110 at one or more merchants over a particular time period (e.g., a week, month, quarter, year, etc.).

FIG. 4 provides a block diagram illustrating the merchant system 400 of FIG. 1 in more detail in accordance with an embodiment of the invention. The merchant system 400 generally includes a processor 410 communicably coupled to a communication interface 430 and a memory system 420. Like the processor 210 described with respect to FIG. 2, the processor 410 comprises the circuitry and logic to perform the various functions of the merchant system 400 described herein. The communication interface 430 includes a network interface 432 and a user interface 434, which may be similar to those described above with respect to FIG. 2.

The memory system 420 may include a web browser application 422 and/or an account communication system client application 421 which comprise computer-executable instructions/code executed by the processor 410 to implement at least some of the functions of the merchant system 400 described herein. These applications also typically provide a graphical user interface (GUI) on the user interface 434 that allows a merchant representative to communicate with the account communication system 500 and/or other devices. In one embodiment of the invention, a merchant representative downloads the account communication system client application 421 from the account communication system 500. In other embodiments of the invention, the merchant interacts with the account communication system 500 by using the web browser application 422 to access and log into a website of the account communication system 500. The merchant may use these applications to enroll in the account communication system 500 and to communicate (or update) price information, credit account or prepaid account information of the consumer, deal or offer information, or the like related to the one or more accounts of the consumer associated with the account communication system 500. The memory system 420 may also include consumer transaction data 424 and/or account balances 423 stored therein.

In some embodiments, the financial management system 500 tracks or monitors the credit accounts and/or prepaid accounts of the consumer. In certain embodiments of the invention, the consumer credit account data is communicated to the merchant system 400 for providing an offer to the consumer when it is determined that the credit account have a balance so that the merchant system 400 can determine offers to present to the consumer. In some instances, this information is provided in real time or substantially real time relative to when the consumer is actually at or near the location of the merchant.

The merchant system 400 may also include, in some embodiments, one or more positioning system devices 470, such as one or more proximity sensors for sensing a consumer mobile device 200 entering or leaving the merchant's location. For example, in one embodiment of the invention, the merchant has one or more sensors/transceivers located at the entrances and exits to the merchant's location that are configured to detect when a consumer 110 going through the entrance or exit holding a mobile device 200 that is configured to communicate a consumer identifier to the sensors/transceivers. The consumer location information gathered by the positioning system devices 470 is then communicated to the account communication system 500 so that the account communication system 500 knows whether the consumer 110 is at, entering, or exiting the merchant facility. In other embodiments of the invention, the merchant may be mobile and, as such, some embodiments of the positioning devices 470 are GPS devices indicating the location of the merchant so that the account communication system 500 can determine the merchant's location relative to the location of one or more consumers and/or one or more mobile devices of the one or more consumers. It will be appreciated that, in some embodiments of the invention, the merchant system 400 does not have any positioning system devices 470 since, for example, a GPS system or a similar system not associated with the merchant system 400 may be used to determine the location of the consumer 110, while the merchant locations may already be known and stored in the memory of the account communication system 500.

FIG. 5 provides a block diagram illustrating the account communication system 500 of FIG. 1 in more detail in accordance with an embodiment of the invention. The account communication system 500 generally includes a processor 510 communicably coupled to a communication interface 530 and a memory system 520. Like the processor 210 described above with respect to FIG. 2, the processor 510 comprises the circuitry and logic to perform the various functions of the account communication system 500 described herein. The communication interface 530 includes a network interface 532 and a user interface 534, which may be similar to those described above with respect to FIG. 2. The memory system 520 includes an account communication system application 521 including computer-executable processor code that instructs the processor 510 to perform the various functions described herein as being performed by the account communication system 500. The memory system 520 also includes merchant and consumer location data 525, consumer transaction data 524, consumer preference data 522, and credit account or prepaid account data 523 stored therein.

The merchant and consumer location data 525 includes location data for each of a plurality of merchants and each of a plurality of participating consumers 110. According to various embodiments, the merchant location data may be determined by public directories containing addresses of various merchants, from the merchant system 400 for some merchants, from the positioning system 150, the financial management system 300, and/or other systems or entities that provide addresses or other location information for one or more merchants. The consumer location data is received from the positioning system 150, which as described above, determines the consumer's current location and/or travel history by tracking the position of the consumer's mobile device 200 over time.

The consumer transaction data 524 includes information about one or more consumer transactions, such as transaction amount, time, location, merchant, products, transaction type, coupons used, payment method, and/or the like. The account communication system 500 may receive the consumer transaction data 524 from the financial management system 300, the merchant system 400, the consumer mobile device 200, and/or other systems. In some embodiments of the invention, the account communication system application 521 (when executed by the processor 510) maps the consumer transaction data 524 against the merchant and consumer location data 525 by, amongst other things, correlating the time of each consumer transaction with the consumer's location at that time and by comparing the consumer's location with the locations of a plurality of merchants. In this way, spending trends are identified for each consumer 110.

The consumer preference data 522 may include, for example, information used by the account communication system 500 to determine the type(s) of credit account(s) for which the consumer 110 is a holder and the respective balances of the credit account(s), when the consumer 110 would like to receive account information, how the consumer 110 would like to receive account information, when the consumer 110 would like for the consumer's location to be tracked by the account communication system 500, the particular distance range between the consumer mobile device and the merchant location when offers should be communicated to the mobile device 200, and/or the like. The consumer preference data 522 may be, for example, consumer-generated and received from the consumer mobile device 200. The consumer preference data 522 may also be determined by the account communication system 500 automatically and/or based on trends identified in the consumer transaction data 524. Some examples of consumer preference data 522 are described in greater detail below with reference to the flow charts shown in FIG. 6.

The credit account or prepaid account data 523 may include, for example, for each account and/or spending account: a credit account or prepaid account balance amount, products and/or services that can be purchased using the credit account or prepaid account, a merchant or type(s) of merchant(s) associated with the credit account or prepaid account, merchant category code(s) associated with the credit account or prepaid account, an issuer of the credit account or prepaid account, and a credit account or prepaid account name. In some embodiments, at least a portion of the credit account or prepaid account data 523 is provided to the account communication system 500 from the financial management system 300, and in other embodiments, the credit account or prepaid account data 523 is provided directly to the account communication system 500.

FIG. 6 illustrates a general process flow 600 for an apparatus or system for providing an offer based at least in part on linking a merchant-specific account to a funded account, in accordance with an embodiment of the present invention.

Referring to block 602, in some embodiments, the holder of the merchant-specific account is a consumer and/or a customer of a merchant or a customer of a financial institution that is issued a merchant-specific account that is useable to purchase goods and/or services at locations and/or affiliated sites of a specific merchant or an specifically identified group of merchants. The holder of the merchant-specific account may enroll, opt-in, or register to receive an offer and/or offers from the merchant by linking a funded account (e.g., checking account, savings account, debit account, and the like) with the merchant-specific account. In some embodiments, the merchant-specific account is a credit account issued by the merchant and/or an affiliate of the merchant. In some embodiments, the merchant-specific account is a prepaid account issued by the merchant and/or an affiliate of the merchant. In some embodiments, the merchant-specific account is a combination of a prepaid account and a credit account issued by the merchant and/or an affiliate of the merchant.

Still referring to block 602, in some embodiments, the system determines whether a consumer is eligible for an offer based on determining that the consumer is a holder of an existing merchant-specific account. The system may determine that the user is a holder of a prepaid account, credit account, or prepaid/credit account issued by the merchant or an affiliate of the merchant. The system may determine that the consumer is a holder of a merchant-specific account in several ways. A first way that the merchant may determine that the consumer is a holder of a merchant-specific account is by comparing information associated with the consumer to merchant-specific account information that is accessible to the merchant or an affiliate of the merchant. Another way that the merchant may determine that the consumer is a holder of a merchant-specific account is upon receiving payment information for a purchase at a location of the merchant or an affiliate of the merchant. For example, the user may be shopping at a location of a merchant and during a check out process present a merchant-specific account for paying for the purchase. In such an example, once the merchant-account is swiped, entered, or somehow received by a transaction machine of the merchant, the system may determine that the user is eligible to link their merchant account to a debit account. In some instances, the transaction machine may queue the pending purchase until the user accepts or declines the offer and when the user accepts the offer the system may use funds from the linked account instead of existing funds or credit that is available in the merchant-specific account.

In block 604, the system prompts the user to link a debit account to the existing merchant-specific account based on determining that the user has a merchant-specific account. In some embodiments, the system prompts the user via a mobile device of the consumer. For example, in some embodiments, the mobile device of the consumer is a cell phone and once the system learns that the user has a merchant-specific account, such as a credit account, the system presents the prompt on a display of the cell phone. In some embodiments, the system is configured to prompt the user at a transaction terminal. In some embodiments, the transaction terminal is an unmanned self-service terminal associated with the merchant and can be located anywhere including at a merchant location. In other embodiments, the transaction terminal is a checkout register at a merchant location with a display device that is visually accessible to the user.

Still referring to block 604, in some embodiments, the prompt to link a debit account to the merchant-specific account is based on the system determining the location of the user. In some embodiments, the system receives information associated with the location of the consumer. This information may be received from a mobile device of the consumer. Based on the location information of the user, the system may then determine that the user is proximate to and/or collocated at a merchant location. For example, in some embodiments, the user is shopping at a location of the merchant and an application running on the mobile phone of the consumer notifies the merchant of the user's location. In such an example, the merchant system may in substantially real-time or near real-time, as the location information is being processed, present the prompt via a mobile phone of the user.

In some embodiments, the prompt comprises information about enrolling into a merchant's rewards and/or offers program. In some embodiments, the prompt is selectable such that upon being selected by a user, the system is configured to present a display or webpage for receiving account information for linking a merchant-specific account to a debit account. The debit account and the merchant-specific account may be linked nearly immediately, substantially in real-time or in real-time, once the user is done providing account information necessary for facilitating the link between accounts.

In block 606, the system receives debit account information for linking the existing merchant-specific account to the debit account of the user. The debit account information relates to any information regarding a checking account, savings accounts, online banking account, or any type of funded account or financial account that would normally have available funds that can be used to make or pay for purchases. The information may also include account numbers for the debit accounts, aliases associated with financial accounts and/or debit account, or the like. Linking the merchant-specific account to the debit account of the user, would allow the user to make purchases using the merchant-specific where the purchases are paid for with funds that originate from the linked debit account. In this way, the user would not have deposit funds into the merchant-specific account when the account is prepaid and nor, would the user have to use credit of the merchant-specific account when the account is a credit account. The offer may further incentive the user to use one or more or any self-service channel accepting the offer or completing the steps necessary for accepting the offer. In this way, the user can avoid busying manned merchant terminals and manned merchant resources for accepting the offer.

At block 608, provide the offer to the user based on successfully linking the debit account to the merchant-specific account. In many embodiments, the offer is only triggered when the debit account of the user is successfully linked to the merchant specific account. In such an embodiment, once the merchant-specific account is successfully linked the user may, in real-time or substantially real-time, use the merchant-specific account to make purchases where the funds for paying for the purchase originate from the linked debit account. The offer may be presented, via a mobile device of the user. For example, the user may select the prompt via a display on his mobile phone and complete the enrollment merchant-specific enrollment process such that once the enrollment is complete, the system presents an activated offer via the display of the mobile device. In some embodiments, the offer is presented via a transaction machine or self-service machine associated with the merchant. For example, when the user completes the merchant-specific account enrollment using a self-service checkout terminal, the terminal may display, print out, or transmit the offer information to a mobile device of the user. In addition, the offer may be provided to the consumer automatically (without human intervention) and in real-time or substantially real-time, as the consumer is arriving or is still proximate to or coincident with the location of the merchant.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system for providing an offer to a user based on linking a financial account to a merchant-specific account, the system comprising:
a memory device;
a communication device; and
a software module stored in the memory, comprising executable instructions that when executed by the processor causes the processor to:
determine whether a user is a holder of an existing merchant-specific account;
prompt the user to link a debit account to the existing merchant-specific account based at least partially on determining that the user is the holder of the existing merchant-specific account;
receive debit account information for linking the existing merchant-specific account to the debit account of the user;
provide, via the communication device, the offer to the user based on successfully linking the debit account to the merchant-specific account.

2. The system of claim 1, wherein the merchant-specific account of the user is a prepaid account or a credit account.

3. The system of claim 1, wherein prompting the user to link a debit account is further based on determining a location of the user and determining that the location of the user is proximate to or coincident with a location of the merchant.

4. The system of claim 1, wherein the prompt is selectable by the user and wherein the prompt is configured to present a display for receiving input from the user relating to the debit account being linked to the merchant-specific account.

5. The system of claim 1, wherein the offer presented to the consumer is for a discount off of a current, prior, or future purchase.

6. The system of claim 1, the memory comprising executable instructions that when executed by the processor further causes the processor to:
send a notification to a merchant associated with the merchant-specific account, the notification comprising information indicating that the consumer is at or near a location of the merchant and further indicating that the consumer is the holder of the merchant-specific account; and
allow the merchant to send, in real-time or substantially real-time, the offer to the mobile device associated with the consumer and while the consumer is at or near the merchant.

7. The system of claim 1, wherein the system for providing the offer is a self-service device useable by the user for receiving the prompt, providing debit account information for linking, and receiving the offer.

8. A computer-implemented method for providing an offer based on a location of a consumer having a credit account associated with a merchant comprising:
using a computer processor to execute computer program code instructions stored in one or more non-transitory computer-readable mediums, wherein said computer program code instructions are structured to cause said computer processor to:
determine whether a user is a holder of an existing merchant-specific account;
prompt the user to link a debit account to the existing merchant-specific account based at least partially on determining that the user is the holder of the existing merchant-specific account;
receive debit account information for linking the existing merchant-specific account to the debit account of the user;
provide, via the communication device, the offer to the user based on successfully linking the debit account to the merchant-specific account.

9. The computer-implemented method of claim 8, wherein the merchant-specific account of the user is a prepaid account or a credit account.

10. The computer-implemented method claim 8, wherein prompting the user to link a debit account is further based on determining a location of the user and determining that the location of the user is proximate to or coincident with a location of the merchant.

11. The computer-implemented method of claim 8, wherein the prompt is selectable by the user and wherein the prompt is configured to present a display for receiving input from the user relating to the debit account being linked to the merchant-specific account.

12. The computer-implemented method of claim 8, wherein the offer presented to the consumer is for a discount off of a current, prior, or future purchase.

13. The computer-implemented method of claim 8, the method further comprising:
sending a notification to a merchant associated with the merchant-specific account, the notification comprising information indicating that the consumer is at or near a location of the merchant and further indicating that the consumer is the holder of the merchant-specific account; and
allowing the merchant to send, in real-time or substantially real-time, the offer to the mobile device associated with the consumer and while the consumer is at or near the merchant.

14. The computer-implemented method of claim 8, wherein the system for providing the offer is a self-service device useable by the user for receiving the prompt, providing debit account information for linking, and receiving the offer.

15. A computer program product for providing an offer based on a location of a consumer having a credit account associated with a merchant, the computer program product comprising a non-transitory computer-readable storage medium having computer-readable program code stored thereon, such that when the computer-readable code is executed by a computer processor it causes the computer to:
determine whether a user is a holder of an existing merchant-specific account;
prompt the user to link a debit account to the existing merchant-specific account based at least partially on determining that the user is the holder of the existing merchant-specific account;
receive debit account information for linking the existing merchant-specific account to the debit account of the user;
provide, via the communication device, the offer to the user based on successfully linking the debit account to the merchant-specific account.

16. The computer program product of claim 15, wherein the merchant-specific account of the user is a prepaid account or a credit account.

17. The computer program product of claim 15, wherein prompting the user to link a debit account is further based on determining a location of the user and determining that the location of the user is proximate to or coincident with a location of the merchant.

18. The computer program product of claim 15, wherein the prompt is selectable by the user and wherein the prompt is configured to present a display for receiving input from the user relating to the debit account being linked to the merchant-specific account.

19. The computer program product of claim 15, wherein the offer presented to the consumer is for a discount off of a current, prior, or future purchase.

20. The computer program product of claim 15, further comprising computer-readable code is executed by a computer processor it causes the computer to:
send a notification to a merchant associated with the merchant-specific account, the notification comprising information indicating that the consumer is at or near a location of the merchant and further indicating that the consumer is the holder of the merchant-specific account; and
allow the merchant to send, in real-time or substantially real-time, the offer to the mobile device associated with the consumer and while the consumer is at or near the merchant.
